(19) United States
(12) Patent Application Publication
(10) Pub. No.: US 2009/0174279 A1
(43) Pub. Date: Jul. 9, 2009

(54) Stator Bar Components with High Thermal Conductivity Resins, Varnishes, and Putties

(75) Inventors: Jeffrey David Sheaffer, Glenville, NY (US); Elena Rozier, Schenectady, NY (US); David John Wardell, Ballston Spa, NY (US)

Correspondence Address: SUTHERLAND ASBILL & BRENNAN LLP, 999 PEACHTREE STREET, N.E., ATLANTA, GA, 30309, US

(73) Assignee: GENERAL ELECTRIC COMPANY, Schenectady, NY (US)

(21) Appl. No.: 11/970,540

(22) Filed: Jan. 8, 2008

(51) Int. Cl. H02K 3/34; H02K 3/04; H01B 3/08

(52) U.S. Cl. 310/201; 310/45; 174/124 G

(57) ABSTRACT

A stator bar. The stator bar may include a conductor, a layer of insulation positioned about the conductor, and a high thermal conductivity varnish to bond the layer of insulation to the conductor.

### TECHNICAL FIELD

The present application relates generally to insulation for electrical machines and more particularly relates to improving the thermal conductivity of resins, varnishes, putties, and other materials used with stator bar components and insulation.

### BACKGROUND OF THE INVENTION

By reducing the thermal resistance of stator bar components, improved heat transfer may be obtained between the stator bar conductors and the stator core. Specifically, reducing the thermal resistance of the stator bar components may reduce the temperature differential between the respective conductors caused by non-uniform magnetic fields therein. Moreover, the current density of the copper conductor may be increased by effectively cooling the conductors.

By way of example, the thermal conductivity of ground wall insulation surrounding the stator bar components has improved in recent years from about 0.3 W/mK to about 0.5 W/mK (Watts per meter per degrees Kelvin) via the addition of high thermal conductivity fillers. The focus to date, however, has been on the insulation as opposed to improving heat transfer among the conductors themselves or between the conductor package and the ground insulation. These conductors interface with the higher thermal conductivity ground insulation products.

There is thus a desire for even further thermal conductivity improvements in stator bar components and insulation. Preferably, such an improved overall stator bar may produce more power from a smaller unit at a more economical cost or at higher efficiency from an existing unit.

### SUMMARY OF THE INVENTION

The present application thus describes a stator bar or any similar type of armature coil. The stator bar may include a conductor, a layer of insulation positioned about the conductor, and a high thermal conductivity varnish to bond the layer of insulation to the conductor.

The application further describes a stator bar. The stator bar may include a number of conductors, a layer of insulation positioned about the conductors with the conductors forming a gap against the layer of insulation, and a high thermal conductivity putty within the gap.

The application further describes a stator bar. The stator bar may include two or more conductor tiers and a vertical separator positioned between the conductor tiers. The vertical separator may include a high thermal conductivity resin.

These and other features of the present application will become apparent to one of ordinary skill in the art upon review of the following detailed description when taken in conjunction with the several drawings and the following claims.

### BRIEF DESCRIPTION OF THE DRAWINGS

FIG. 1 is a perspective view of a stator bar as described herein.

FIG. 2 is a side cross-sectional view of a stator bar as is described herein.

FIG. 3 is a side cross-sectional view of a stator bar as is described herein.

FIG. 4 is a perspective view of a Roebeled stator bar.

FIG. 5 is a side cross-sectional view of a stator bar as is described herein.

### DETAILED DESCRIPTION

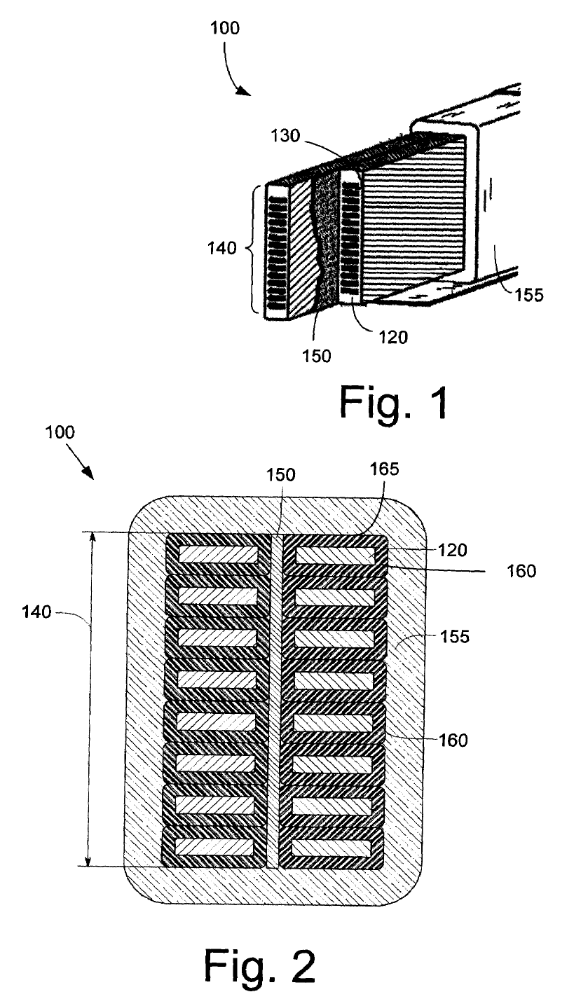

Referring now to the drawings, in which like numerals refer to like elements throughout the several views, FIG. 1 shows a stator bar 100 as is described herein. The stator bar 100 may be used with electrical machines as is known in the art. An electrical machine generally may have multiple stator bars 100. The multiple stator bars 100 may be identical and may be disposed upon or about each other as is known.

Generally described, each stator bar 100 may include a number of conductors 120. The conductors 120 may be made out of copper, copper alloys, aluminum, or similar materials. A layer of conductor insulation 130 may separate the individual conductors 120. In this example, the conductor insulation 130 may include a typical E-Glass, Daglass, or a similar type of glass material. The E-Glass may be a low alkali borosilicate fiberglass with good electro-mechanical properties and with good chemical resistance. E-Glass, or electrical grade glass, has excellent fiber forming capabilities and is used as the reinforcing phase in fiberglass. The E-Glass may have a thermal conductivity of about 0.99 W/mK. The Daglass may be a yarn with a mixture of polyester and glass fibers. The Daglass may have a thermal conductivity of about 0.4 W/mK. A glass cloth made from the E-Glass, the Daglass, or from similar types of materials may have any desired woven densities, weights, thicknesses, strengths, and other properties.

In the embodiment as shown, the stator bar 100 may include two or more tiers 140 of the conductors 120. Any number of tiers 140 may be used. The tiers 140 may be separated by a vertical separator 150. Typical vertical separators 150 may include paper, felt, or a glass fabric that is treated with a partially-cured resin that, when cured, flows and bonds the tiers 140 together. The separators 150 also provide additional electrical insulation.

The tiers 140 also may be surrounded by one or more layers of ground insulation 155. As described above, the ground insulation 155 commonly may be constructed of a combination of a mica paper, a glass cloth or unidirectional glass fibers, and a resin binder in multilayers to form a composite.

FIG. 2 shows a stator bar 100 with an improved conductor insulator 160. The conductor insulator 160 may include the E-Glass or the Daglass of the conductor insulation 130 with the addition of a high thermal conductivity varnish 165. The varnish 165 may be used to fill and bond the E-Glass, the Daglass, or other material of the conductor insulator 160 to the conductor 120 and is then cured. Typically, the varnish 165 may be made out of epoxy resin, polyester resin, or similar types of materials. The high thermal conductivity varnish 165 also may include high thermal conductivity fillers so as to improve the heat transfer between the conductors 120. In this example, the high thermal conductivity fillers may include boron nitride (BN), aluminum nitride (AlN), silicon nitride (Si3N4), aluminum oxide (Al2O3), magnesium oxide (MgO), zinc oxide (ZnO), strontium titanate (SrTiO3), titanium dioxide (TiO2), silica (SiO2), diamond (C), and similar types of materials. The varnish 165 may have a thermal conductivity of about 0.2 (unfilled) W/mK or more. Thermal conductivities of 0.8 W/mK have been shown with the addition of high thermal conductivity fillers to the varnish. Even better thermal conductivity may be expected with the use of, for example, diamond (C).

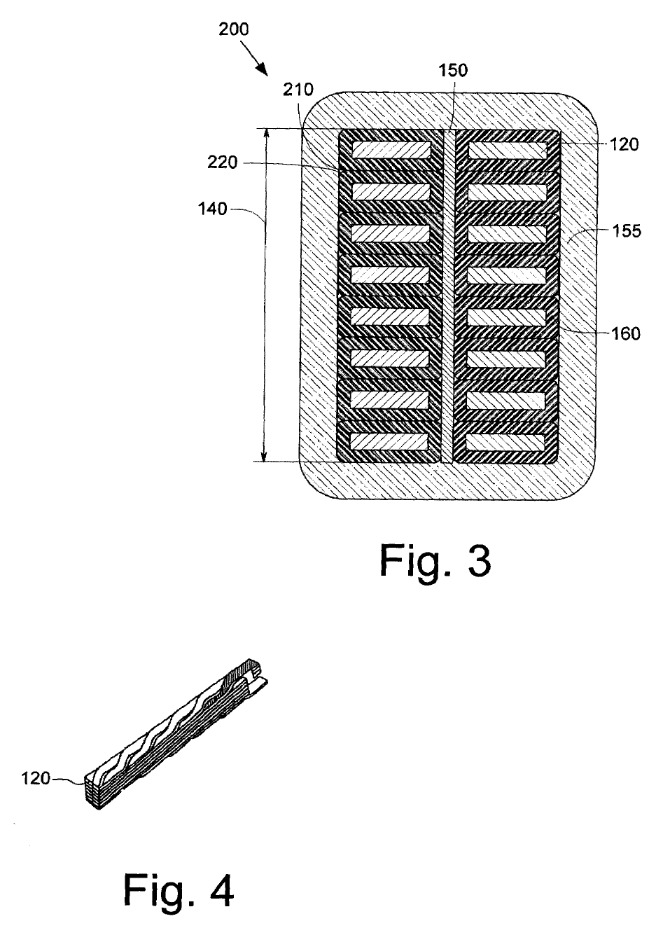

FIG. 3 shows a further stator bar 200 as is described herein. The stator bar 200 may be similar to that described above, but with the addition of a high thermal conductivity putty 210 positioned within the “V's” 220 between the radiused corners of the individual conductors 120 and the ground insulation 155. The V's 220 are usually filled with a resin that has filtered through the ground insulation 155 and tends to be a pure organic resin with low thermal conductivity (about 0.18 W/mK). In this case, the high thermal conductivity putty 210 may be applied either directly or applied to a carrier fabric such as a paper, felt, or glass cloth or tape and then may be applied to the surface of the conductor 120. The high thermal conductivity putty 210 may include the high thermal conductivity fillers described above such as boron nitride (BN), aluminum nitride (AlN), silicon nitride (Si3N4), aluminum oxide (Al2O3), magnesium oxide (MgO), zinc oxide (ZnO), strontium titanate (SrTiO3), titanium dioxide (TiO2), silica (SiO2), diamond (C) and similar materials as are described herein. The putty 210 may have a thermal conductivity of about 0.2 (unfilled) W/mK or more. The putty 210 may serve to improve the heat transfer between the conductors 120 and the ground insulation 155.

As is shown in FIG. 4, the conductors 120 may be spiraled in a manner referred to as Roebeling. The Roebeling process results in each conductor 120 spiraling down the slot of a generator in a rectangular bar shape. The result is an extra conductor height on one side of a two-tier stator bar 100. To make the stator bar 100 a rectangle again, the high conductivity putty 210 also may be used to fill the void space around the Roebel crossover. The putty 210 thus improves heat transfer from the conductors 120 to the ground insulation 155.

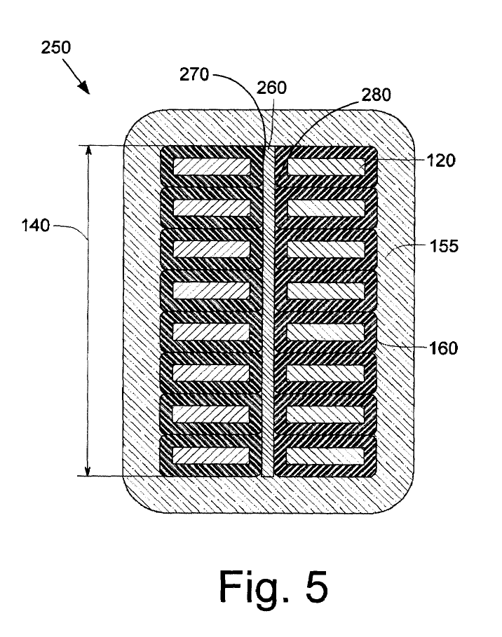

FIG. 5 shows a further embodiment of a stator bar 250. The stator bar 250 may be similar to those described above, but with an improved vertical separator 260. As above, the improved vertical separator 260 may be a mixture of paper, felt, glass fabric that is treated with a high thermal conductivity resin 270 that may include the high thermal conductivity fillers described above such as boron nitride (BN), aluminum nitride (AlN), silicon nitride (Si3N4), aluminum oxide (Al2O3), magnesium oxide (MgO), zinc oxide (ZnO), strontium titanate (SrTiO3), titanium dioxide (TiO2), silica (SiO2), diamond (C), and similar materials as described above. The resin 270 may have a thermal conductivity of about 0.2 (unfilled) W/mK or more. The resin 270 may flow and fill a number of diamond-shaped areas 280 between the conductors 120 similar to the “V's 220” described above. The gaps between the radiused corners of the conductors 120 and the vertical separator 260 form the “V's” 220 as described above. The combination of two opposing “V's” 220 forms a diamond shape 280. The improved vertical separator 260 with the improved resin 270 therefore may improve heat transfer between the conductors 120.

The use of the high thermal conductivity varnish 165, the putty 210, and the resin 270 thus may increase the thermal conductivity of the stator bar 100, both between the conductors 120 and between the conductors 120 and the ground insulation 155. For example, certain conductors 120 may be closer to the source of the magnetic field and hence may be subject to higher magnetic fields. Such higher magnetic fields may induce higher currents so as to set up a temperature differential between the closer and the farther conductors 120 within the stator bar 100. The improved thermal conductivity described herein may allow for improved heat flow and a lower temperature difference between the respective conductors 120.

Likewise, certain stator bars 100 may use hollow conductors to serve as passages for fluid flow therethrough so as to remove heat from the stator bar 100 as a whole. In such designs, the higher thermal conductivity should allow more efficient cooling and a higher ratio of solid to hollow conductors 120. As a result, the amount of copper and the amount of conductors 120 may increase in a stator bar 100 of the same size.

It should be apparent that the foregoing relates only to the preferred embodiments of the present application and that numerous changes and modifications may be made herein by one of ordinary skill in the art without departing from the general spirit and scope of the invention as defined by the following claims and equivalents thereof.

We claim:

1. A stator bar, comprising:
a conductor;
a layer of insulation positioned about the conductor; and
a high thermal conductivity varnish to bond the layer of insulation to the conductor.

2. The stator bar of claim 1, wherein the high thermal conductivity varnish comprises a high thermal conductivity filler.

3. The stator bar of claim 1, wherein the high thermal conductivity varnish comprises boron nitride (BN), aluminum nitride (AlN), silicon nitride (Si3N4), aluminum oxide (Al2O3), magnesium oxide (MgO), zinc oxide (ZnO), strontium titanate (SrTiO3), titanium dioxide (TiO2), silica (SiO2), or diamond (C).

4. The stator bar of claim 1, wherein the high thermal conductivity varnish comprises a thermal conductivity of more than about 0.2 W/mK.

5. The stator bar of claim 1, wherein the layer of insulation comprises a glass component.

6. A stator bar, comprising:
a plurality of conductors;
a layer of insulation positioned about the conductors;
the conductors forming a gap against the layer of insulation; and
a high thermal conductivity putty within the gap.

7. The stator bar of claim 6, wherein the high thermal conductivity putty comprises a high thermal conductivity filler.

8. The stator bar of claim 6, wherein the high thermal putty component comprises boron nitride (BN), aluminum nitride (AlN), silicon nitride (Si3N4), aluminum oxide (Al2O3), magnesium oxide (MgO), zinc oxide (ZnO), strontium titanate (SrTiO3), titanium dioxide (TiO2), silica (SiO2), or diamond (C).

9. The stator bar of claim 6, wherein the high thermal conductivity putty comprises a thermal conductivity of more than about 0.2 W/mK.

10. The stator bar of claim 6, wherein the layer of insulation comprises a glass component.

11. The stator bar of claim 6, wherein the gap comprises a V-like shape.

12. The stator bar of claim 6, wherein the high thermal conductivity putty is applied directly to the gap.

13. The stator bar of claim 6, wherein the high thermal conductivity putty is applied to the gap via a carrier material.

14. The stator bar of claim 6, wherein the conductors comprise a Roebeled configuration.

15. A stator bar, comprising:
two or more conductor tiers; and
a vertical separator positioned between the tiers;
wherein the vertical separator comprises a high thermal conductivity resin.

16. The stator bar of claim 15, wherein the high thermal conductivity resin comprises a high thermal conductivity filler.

17. The stator bar of claim 15, wherein the high thermal conductivity resin comprises boron nitride (BN), aluminum nitride (AlN), silicon nitride (Si3N4), aluminum oxide (Al2O3), magnesium oxide (MgO), zinc oxide (ZnO), strontium titanate (SrTiO3), titanium dioxide (TiO2), silica (SiO2), or diamond (C).

18. The stator bar of claim 1, wherein the high thermal conductivity resin comprises a thermal conductivity of more than about 0.2 W/mK.

19. The stator bar of claim 15, wherein the vertical separator comprises a paper, felt, or glass component.

20. The stator bar of claim 15, wherein two or more conductor tiers form a plurality of diamond-like gaps therebetween and wherein the high thermal conductivity resin fills the plurality of diamond-like gaps.
